(19) United States
(12) Patent Application Publication
(10) Pub. No.: US 2019/0061544 A1
(43) Pub. Date: Feb. 28, 2019

(54) BATTERY EXCHANGE SYSTEM FOR BATTERY-POWERED VEHICLES USING AUXILIARY BATTERY

(71) Applicant: General Electric Company, Schenectady, NY (US)

(72) Inventors: Patrick Lee Jansen, Schenectady, NY (US); Ricky Jared Terry, Daniels, WV (US); Taral Shah, Lawrence Park, PA (US)

(21) Appl. No.: 16/100,375

(22) Filed: Aug. 10, 2018

Related U.S. Application Data
(60) Provisional application No. 62/549,526, filed on Aug. 24, 2017.

(51) Int. Cl. B60L 11/18; B60S 5/06

(52) U.S. Cl. CPC B60L 11/1833; B60L 11/1816; B60S 5/06; B60L 11/1822

(57) ABSTRACT

A system includes an auxiliary battery configured to be disposed onboard a vehicle having an electrically powered propulsion system that is configured to also be powered by detachable main batteries, and a converter configured to be electrically coupled with the auxiliary battery and the propulsion system of the vehicle. The converter is configured to direct electric energy stored in the auxiliary battery to the propulsion system for powering the propulsion system while the vehicle is detached from a depleted detachable main battery and before the vehicle is connected with a charged detachable main battery.

### CROSS-REFERENCE TO RELATED APPLICATIONS

This application claims priority to U.S. Provisional Application 62/549,526, which was filed on 24 Aug. 2017, and the entire disclosure of which is incorporated herein by reference.

### FIELD

The subject matter described herein relates to vehicle power systems, such as vehicles that are at least partially powered by energy storage devices such as batteries.

### BACKGROUND

Some vehicles are at least partially electrically powered by one or more batteries onboard the vehicles. For example, some underground mining vehicles may be electric vehicles powered by batteries. The batteries can be carried by battery-powered scoops on one end of the mining vehicles. A depleted battery carried by a vehicle can be exchanged for a charged battery at a charging station.

Battery exchange systems currently in use with battery-powered scoops operating predominately in coal mines today typically require a jumper cable to be connected between the vehicle and the charged battery. This cable supplies power from the charged battery at the charging station (e.g., on the ground and connected to a power source such as a utility grid) to the vehicle to enable the vehicle to move over to the new battery after dismounting (e.g., dropping off) the depleted battery.

Typically, at least one additional helper person is needed at the battery exchange location to handle the jumper cable to ensure that the cable does not get damaged (e.g., run over) by the vehicle while the vehicle is jogging between batteries. Additionally, the jumper cable can introduce shock hazard risks to the helper person if the cable is damaged.

Some mining systems use a battery carousel system to exchange or swap out depleted batteries. The carousel carries two to three batteries and rotates to enable exchanging batteries with vehicles without needing to move the vehicle. One disadvantage of this approach is that a significant investment is required for the carousel system.

Another approach utilizes an overhead crane to lift out a depleted battery and to lower in a new charged battery. A disadvantage of this approach is that the mine must have a crane at the battery exchange (and charging) location. Moreover, continually lifting large and heavy batteries introduces significant safety risks, and can require significant operator training and care.

Another approach places a low-voltage auxiliary battery onboard the mining vehicle. The low-voltage battery is used to drive and operate the vehicle during time intervals of the battery changing process when the main high-voltage battery of the vehicle is disconnected from the power systems of the vehicle. A rotary switch with contactors alternatively switches the low-voltage auxiliary battery and the main high-voltage battery to the vehicle for operation. But, at no time are the auxiliary battery and the main battery allowed to be connected to the vehicle at the same time due to the differing voltages. This can add cost and complexity to the electrical circuits of the vehicle.

### BRIEF DESCRIPTION

In one embodiment, a system includes an auxiliary battery configured to be disposed onboard a vehicle having an electrically powered propulsion system that is configured to also be powered by detachable main batteries, and a converter configured to be electrically coupled with the auxiliary battery and the propulsion system of the vehicle. The converter is configured to direct electric energy stored in the auxiliary battery to the propulsion system for powering the propulsion system while the vehicle is detached from a depleted detachable main battery and before the vehicle is connected with a charged detachable main battery.

In one embodiment, a method includes moving a vehicle having an electrically powered propulsion system that is powered by a first main battery toward a charged second main battery, electrically decoupling the first main battery from the vehicle, moving the vehicle toward the charged second main battery by powering the propulsion system of the vehicle using an auxiliary battery that is onboard the vehicle after the first main battery is decoupled from the vehicle, electrically coupling the charged second main battery with the vehicle, and moving the vehicle by powering the propulsion system of the vehicle using the charged second main battery.

In one embodiment, a system includes an auxiliary battery configured to be disposed onboard a vehicle having an electrically powered propulsion system and a detachable main battery configured to be disposed onboard the vehicle and to power the propulsion system to move the vehicle. The main battery is configured to be detached from the propulsion system for charging the main battery. The system also includes a converter configured to be electrically coupled with the auxiliary battery, the propulsion system, and the main battery. The converter is configured to direct electric energy stored in the auxiliary battery to the propulsion system for powering the propulsion system while the vehicle is detached from the main battery and before the vehicle is re-connected with the main battery or a replacement main battery.

### BRIEF DESCRIPTION OF THE DRAWINGS

The present inventive subject matter will be better understood from reading the following description of non-limiting embodiments, with reference to the attached drawings, wherein below:

FIG. 1 illustrates one embodiment of a rapid battery exchange system onboard a vehicle;

FIG. 2 illustrates a swap-out process for switching batteries of the vehicle without the rapid battery exchange system shown in FIG. 1;

FIG. 3 illustrates a swap-out process for switching batteries of the vehicle with the rapid battery exchange system shown in FIG. 1;

FIG. 4 schematically illustrates the vehicle and the rapid battery exchange system shown in FIG. 1 according to one embodiment; and

FIG. 5 illustrates a flowchart of one embodiment of a method for rapidly exchanging batteries of a vehicle.

### DETAILED DESCRIPTION

One or more embodiments of the inventive subject matter described herein provide rapid battery exchange systems and methods for battery-powered vehicles using auxiliary batteries. The systems and methods described herein provide the ability to rapidly exchange main batteries on battery-powered vehicles such as battery-powered mining vehicles (e.g., load-haul-dump vehicles, or LHD vehicles), scoop vehicles, battery-powered haul trucks, and the like.

The system includes a small auxiliary battery and power converter that is fixed within the vehicle. The vehicle can include a rapid-detach system (RDS) for the lifting, mounting, and releasing of a main battery to or from the vehicle. A depleted main battery on the vehicle is typically lowered to the ground and mechanically detached or released by the RDS, and is electrically disconnected. The vehicle then jogs to the location of a charged main battery while under power of the auxiliary battery that is onboard the vehicle. Using the auxiliary battery power, the vehicle RDS lifts and mounts the charged main battery to the vehicle. The vehicle then motors back to the mine working area to complete another operating shift while under power from the charged main battery.

Simultaneously or concurrently, the auxiliary power converter regulates additional power flow from the charged main battery to the auxiliary battery to recharge the auxiliary battery. To reduce or minimize stress on the main battery and impact on vehicle performance, the auxiliary power converter will typically extract charging power only during periods of low vehicle utilization (e.g., when the vehicle is idle or operating at a low power that does not propel the vehicle).

One or more embodiments of the systems and methods provide a fully-integrated battery exchange system within the mining vehicle, thereby eliminating or reducing the need for a jumper cable to be connected and managed. The speed of the battery exchange process can be increased, resulting in reduced downtime of the vehicle and increased mining productivity. Furthermore, the need for additional mining staff to manage the jumper cables during battery exchange can be reduced or eliminated, thereby reducing overall mine production costs and reducing safety risks.

While the description herein focuses on electrically powered mining vehicles, one or more embodiments of the systems and methods described herein can be used with other types of vehicles, such as electric automobiles, hybrid automobiles, or other vehicles that are at least partially propelled using electric current.

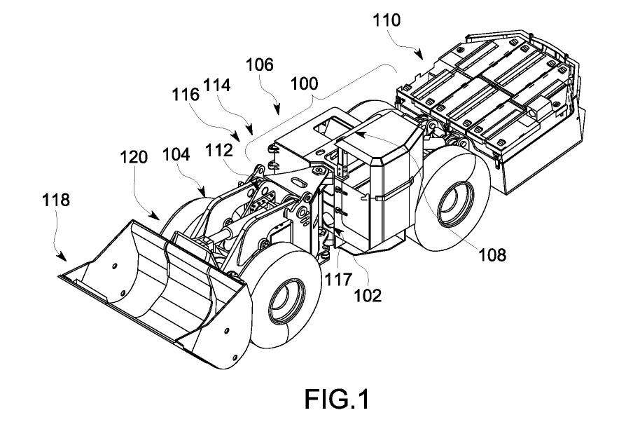

FIG. 1 illustrates one embodiment of a rapid battery exchange system 100 onboard a vehicle 102. The vehicle 102 is a mining vehicle, such as a load-haul-dump vehicle used in underground mines. The vehicle 102 includes front chassis 104 and a rear chassis 106 that can be coupled with each other in a hinged manner at an articulation joint 112 to allow the vehicle 102 to move around corners in relatively tight or confined spaces of a mine. A battery detach system 108 is coupled with the rear chassis 106 and can grasp a main battery 110 (e.g., the box or tray of the main battery 110) having one or more battery cells disposed therein. The batteries in the box or tray can be high voltage batteries (e.g., batteries storing two hundred forty to eight hundred volts of direct current in one embodiment, or two hundred forty to three hundred twenty volts of direct current in another embodiment). Low voltage batteries can be batteries operating in the range of sixty to two hundred volts of direct current in one embodiment. The battery detach system 108 can include motors and arms that move to grasp and raise a new or charged main battery 110 from a surface (e.g., the ground on which the vehicle 102 is disposed) and that can move to lower and release an old or depleted battery 110.

An operator cab 117 of the vehicle 102 provides a location where one or more persons can sit while operating movements and operations of the vehicle 102. The vehicle 102 includes a propulsion system 114, which can include one or more traction motors, motor drives, inverters, and the like. The propulsion system 114 is powered by electric current received from the batteries in the battery 110 and/or an auxiliary battery 116 of the system 100, described below. A bucket 118 of the vehicle 102 is moved using lift arms and hydraulic cylinders 120 which also can be controlled using current supplied from the batteries in the battery 110.

As described herein, the auxiliary battery 116 can be one or more battery cells that store energy used to power the vehicle 102 during time periods when the vehicle 102 is not powered by energy stored in batteries of the main battery 110. The auxiliary battery 116 can supply current to power the propulsion system 114 and/or the detach system 108 for moving the vehicle 102 from a location where a depleted main battery 110 was lowered and released to a location where a charged main battery 110 is available, and for powering the detach system 108 to grasp the charged main battery 110 and couple the charged main battery 110 to the electric circuits of the vehicle 102. The auxiliary battery 116 can be a low voltage battery that powers the propulsion system 114 and/or detach system 108 through a direct current to direct current (DC/DC) converter. The auxiliary battery 116 can be charged by the batteries in the battery box or tray. For example, at least some energy in the main battery 110 can be directed through the converter into the auxiliary battery 116 while the vehicle 102 is operating at idle or another low power setting. The converter allows for the low voltage auxiliary battery 116 and the high voltage batteries in the main battery 110 to remain conductively coupled to the same circuit or circuits in the vehicle 102 that supply power to the propulsion system 114 and/or detach system 108.

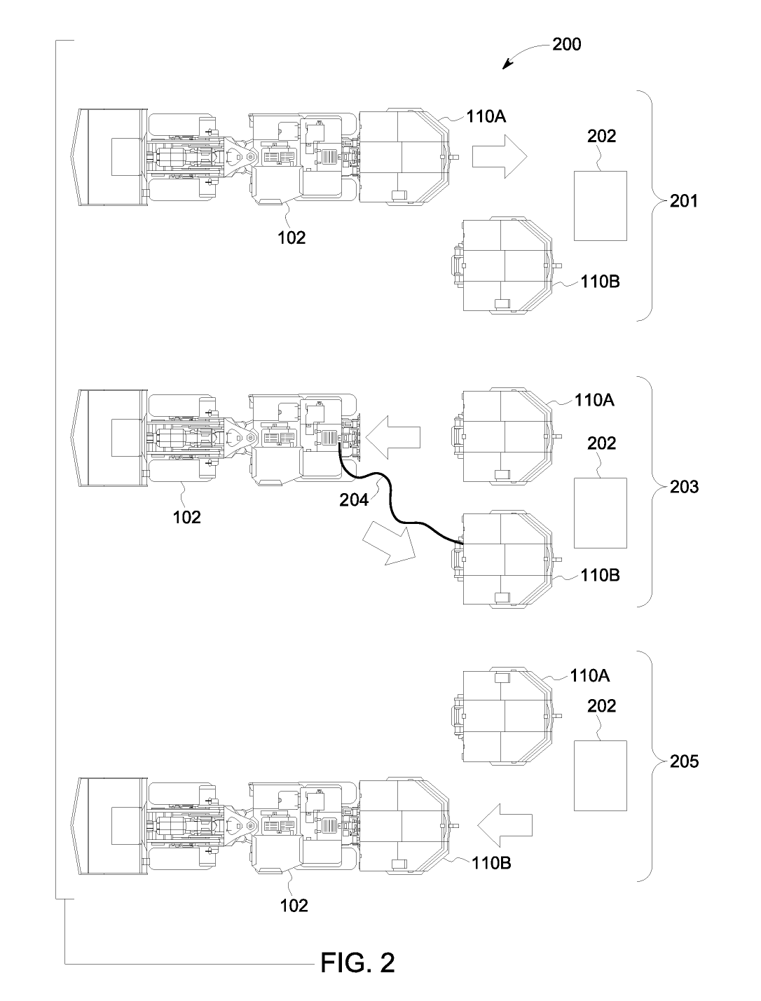

FIG. 2 illustrates a swap-out process 200 for switching batteries of the vehicle 102 without the rapid battery exchange system 100. In the process 200, the vehicle 102 is powered by batteries in a first main battery 110A. The batteries in the main battery 110A may be relatively close to being depleted of stored energy, such as within 10% or another threshold of being fully depleted of electric energy. At 201, the vehicle 102 can approach a charging station 202 that supplies current to one or more other main batteries 110 from a power source (e.g., a utility grid) for charging the battery main batteries 110. In the illustrated example, a second main battery 110B is near the charging station 202 and is at least partially charged by the charging station 202.

The batteries in the first main battery 110A power the vehicle 102 to move relatively close to the charging station 202 and/or charged main battery 110B. For example, the vehicle 102 can be powered by the first main battery 110A to move within a distance of the charged main battery 110B that is no longer than a jumper cable 204. The detach system 108 can lower the depleted or nearly depleted main battery 110A and detach the same from the vehicle 102.

At 203, an operator can couple the jumper cable 204 with the circuitry of the vehicle 102 and with the charged main battery 110B. This allows for the propulsion system 114 and the detach system 108 of the vehicle 102 to be powered by current conducted from the charged main battery 110B to the vehicle 102 via the jumper cable 204. The vehicle 102 can then move to a location that is at or near the charged main battery 110B and the detach system 108 can grasp, lift, and conductively couple the charged main battery 110B with the circuits of the vehicle 102 that power the propulsion system 114 and the detach system 108. At 205, the operator detaches the jumper cable 204 from the vehicle 102 and the vehicle 102 can leave the charging station 202 while being powered by the charged main battery 110B.

As described above, use of the jumper cable 204 in this way can introduce risks to the operator and the cable. The system 100 can be used to avoid use of the jumper cable 204 to switch out the main battery 110 of the vehicle 102.

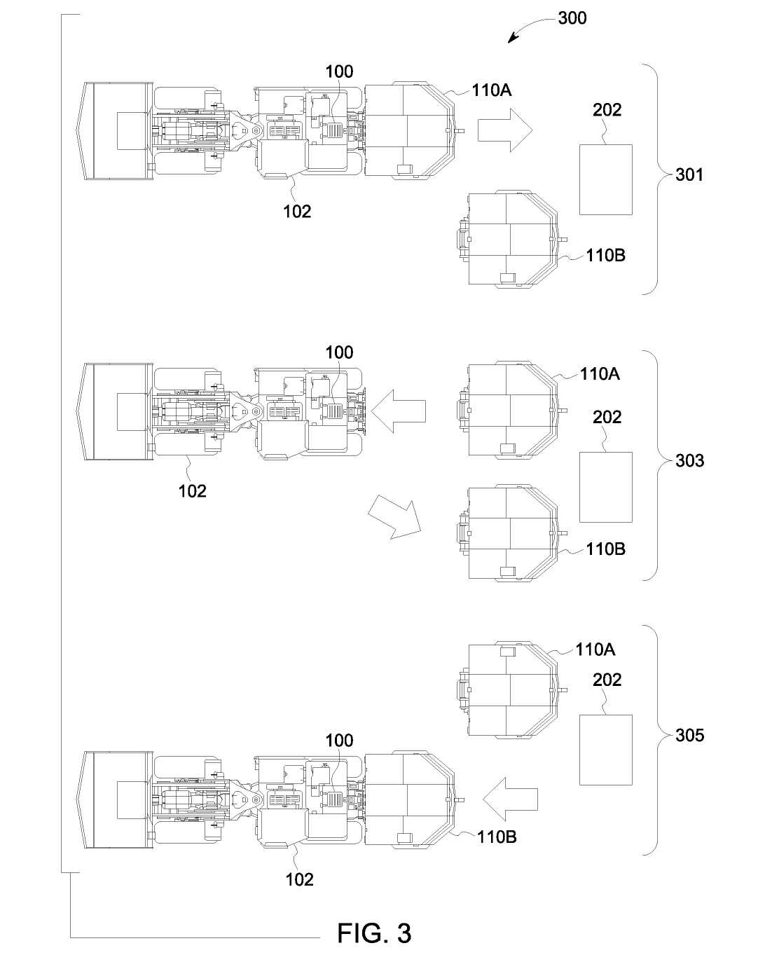

FIG. 3 illustrates a swap-out process 300 for switching batteries of the vehicle 102 with the rapid battery exchange system 100. In the process 300, the vehicle 102 includes the system 100 and no jumper cable 204 or other external cable is used to connect the vehicle 102 with a main battery 110 that is not connected by the detach system 108.

In the process 300, the vehicle 102 is powered by batteries in the first main battery 110A. The batteries in the main battery 110A may be relatively close to being depleted of stored energy, such as within 10% or another threshold of being fully depleted of electric energy. At 301, the vehicle 102 can approach the charging station 202 with the charged second main battery 110B near the charging station 202. Optionally, the vehicle 102 can approach the charged second main battery 110B that is not near the charging station 202. The vehicle 102 can be powered by the batteries in the first main battery 110A and/or by the auxiliary battery 116.

At 203, the detach system 108 lowers the depleted or nearly depleted main battery 110A and detaches the same from the vehicle 102. The propulsion system 114 and/or detach system 108 are powered by the auxiliary battery 116 alone to move the vehicle 102 and detach system 108 toward the charged main battery 110B.

At 205, the detach system 108 grasps the charged main battery 110B and couples the charged main battery 110B with the circuitry of the vehicle 102 so that the propulsion system 114 and/or detach system 108 are powered by the charged main battery 110B. The vehicle 102 may then leave to perform other tasks under the power of the charged main battery 110B.

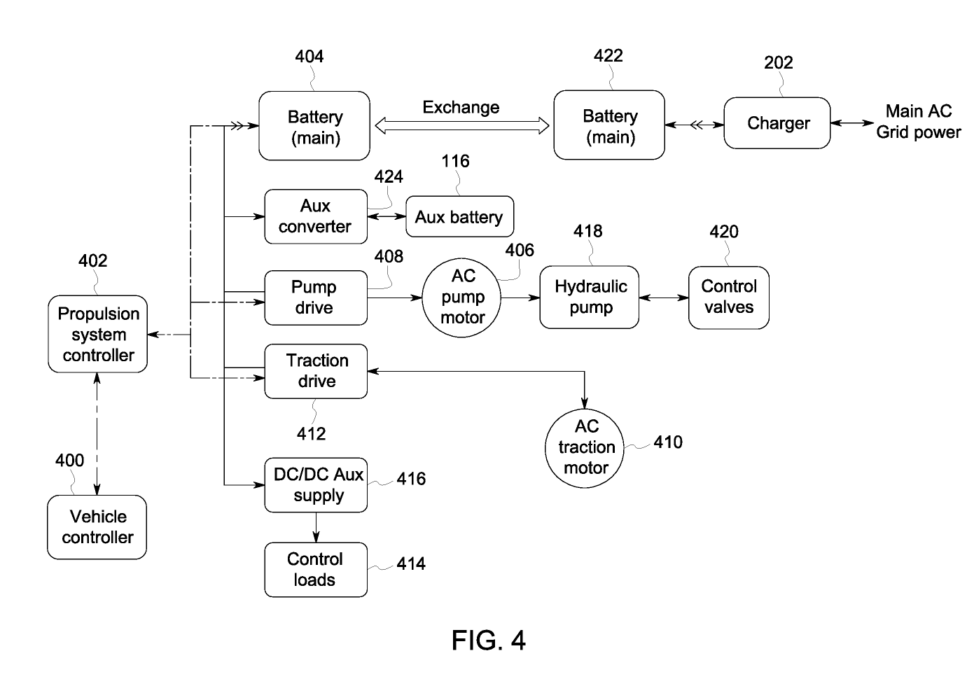

FIG. 4 schematically illustrates the vehicle 102 and the rapid battery exchange system 100 according to one embodiment. The vehicle 102 includes a vehicle controller 400 and a propulsion system controller 402 that represent hardware circuitry that includes and/or is connected with one or more processors (e.g., one or more microprocessors, field programmable gate arrays, integrated circuits, etc.). The controller 400 controls operations of the vehicle 102 and/or system 100 based on inputs provided by the operator of the vehicle 102 and/or operating states of components of the vehicle 102. The controller 402 controls operation of the propulsion system 114 to control movement and/or braking of the vehicle 102.

The controllers 400, 402 communicate with a main battery 404, which represents the battery cells in the main battery 110 currently coupled with the vehicle 102. The main battery 404 can power several loads of the vehicle 102, such as a pump motor 406 (which is controlled via a pump drive or driver 408), one or more traction motors 410 (which are controlled via a traction drive or driver 412), one or more other loads 414 (“Control loads” in FIG. 4, which are controlled via a DC/DC auxiliary supply converter or driver 416). The pump motor 406 can power one or more hydraulic pumps 418 that are controlled by control valves 420 for lifting or lowering the bucket 118, steering the vehicle 102, and/or braking the vehicle 102. The traction motor(s) 410 can rotate one or more wheels of the vehicle 102 via one or more axles and/or gears.

One or more of the connections between the components in FIG. 4 can represent conductive pathways, such as direct current buses, between the components. These pathways can conduct electric current between the components. For example, the batteries 110A, 110B, 404 can conduct current to the propulsion system and detach system via a direct current (DC) bus.

As described above, the detach system 108 can release the main battery 404 in exchange for another main battery 422 (e.g., the second battery 110B) at or near the charging station 202. The rapid battery exchange system 100 includes the auxiliary battery 116 which is conductively coupled with circuitry of the vehicle 102 by an auxiliary converter 424, such as a DC/DC converter. The converter 424 can connect the low voltage battery 116 with the same circuit or circuits that conductively couple the main battery 404 or 422 with the propulsion system 114 (e.g., the traction motor 410). This converter 424 permits both the low voltage auxiliary battery 116 to be conductively coupled with the same circuit as the high voltage battery 404, 422. The converter 424 can step up or step down the voltage conducted to or from the auxiliary battery 116 to allow the battery 116 to power the propulsion system 114 and/or detach system 108 and/or to allow the battery 116 to be charged with at least some current from the battery 404 and/or 422.

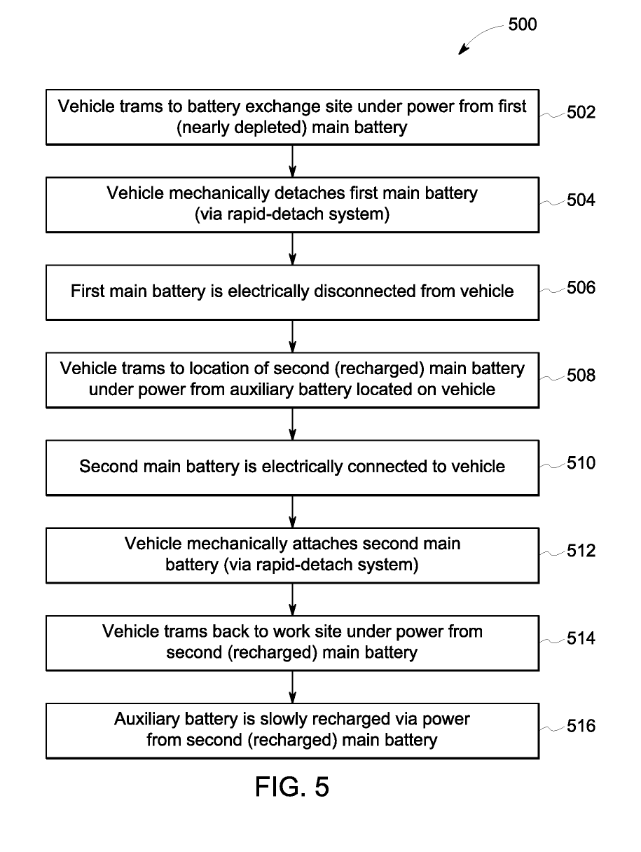

FIG. 5 illustrates a flowchart of one embodiment of a method 500 for rapidly exchanging batteries of a vehicle. The method 500 can be used to power the vehicle 102 during an exchange of main batteries 110 of the vehicle 102 without using the jumper cable 204. At 502, the vehicle 102 trams (e.g., moves) to a battery exchange site (e.g., at or near the charging station 202) under power from the first main battery 110A. At 504, the vehicle mechanically detaches from the first main battery 110A. At 506, the first main battery 110A is electrically disconnected from the vehicle 102 such that the first main battery 110A can no longer power any loads of the vehicle 102.

At 508, the vehicle 102 moves to the location of the second, charged main battery 110B under power from the auxiliary battery 116 of the system 100. As described above, the auxiliary battery 116 is disposed onboard the vehicle 102 such that the auxiliary battery 116 moves with the vehicle 102. Having the power source that powers the vehicle 102 (during a time period that the vehicle 102 is not connected with a main battery 110) onboard the vehicle 102 allows the vehicle 102 to travel farther than current known systems and methods. For example, the distance that the vehicle 102 can travel under the power of the battery 116 is not limited by the length of any cable, but may be limited only by the amount of energy stored in the battery 116 onboard the vehicle 102. The vehicle 102 can move (while being powered only by the onboard auxiliary battery 116) to the second main battery 110B.

At 510, the second (charged) main battery 110B is electrically coupled with the vehicle 102. For example, the second battery 110B can be conductively coupled with one or more circuits of the vehicle 102 that are used to conduct current to the propulsion system 114 and/or the detach system 108 for powering the systems 108, 114. The main battery 110B and the auxiliary battery 116 can both be conductively coupled with the same circuit or circuits that supply power to the systems 108, 114 at the same time. At 512, the second main battery 110B is mechanically coupled with the vehicle 102. For example, the detach system 108 can grasp and mechanically lock the main battery 110B onto the vehicle 102 so that the main battery 110B remains coupled with the vehicle 102 during movement of the vehicle 102.

At 514, the vehicle moves and performs other operations under the power from the main battery 110B. For example, the vehicle 102 may move away from the charging station 202 and return to operating within the mine using power from the main battery 110B. At 516, the auxiliary battery is charged using energy stored in the main battery. For example, the auxiliary battery 116 can be at least partially charged over an extended time period by the main battery 110B. This recharging can occur while the vehicle 102 is idle or is not consuming a significant amount of current from the main battery 110B.

In an alternative embodiment of the method 500, two or more of the operations can be switched in order. For example, the operations at 504 and 506 can be performed in another order and/or the operations at 510 and 512 can be performed in another order. The battery 110A can be electrically disconnected from the vehicle 102 (at 506) before the battery 110A is mechanically decoupled from the vehicle 102 (at 504) and/or the battery 110B can be electrically coupled with the vehicle 102 (at 510) after the battery 110B is mechanically coupled with the vehicle 102 (at 512).

In one embodiment, a battery exchange system includes an underground mining vehicle, an electric propulsion system associated with the underground mining vehicle, a first main battery detachably mounted on the vehicle and electrically connected to provide electric propulsion power to the vehicle via a direct current (DC) electrical bus, a second main battery located off the vehicle, a detach system for mechanically detaching the first main battery from the vehicle and attaching the second main battery to the vehicle, a battery charging system located off the vehicle and configured to provide charging power to the first or second main battery when detached from the vehicle, an auxiliary battery mounted on the vehicle, and a power converter comprising circuitry configured to provide controlled bi-directional power and/or current flow between the auxiliary battery and the DC electrical bus. The power converter is controlled to provide sufficient voltage and power to the DC electrical bus from the auxiliary battery to enable the vehicle to tram to the second main battery with the first main battery mechanically detached and electrically disconnected from the vehicle. The power converter is further controlled to provide charging power to the auxiliary battery from the second main battery after the second main battery is electrically connected to the vehicle.

In one embodiment, a system includes an auxiliary battery configured to be disposed onboard a vehicle having an electrically powered propulsion system that is configured to also be powered by detachable main batteries, and a converter configured to be electrically coupled with the auxiliary battery and the propulsion system of the vehicle. The converter is configured to direct electric energy stored in the auxiliary battery to the propulsion system for powering the propulsion system while the vehicle is detached from a depleted detachable main battery and before the vehicle is connected with a charged detachable main battery.

Optionally, the auxiliary battery is a low voltage battery.

Optionally, the detachable main batteries are high voltage batteries.

Optionally, the converter is configured to charge the auxiliary battery by directing at least some electric energy stored in the charged detachable main battery to the auxiliary battery.

Optionally, the auxiliary battery is configured to power the vehicle after the vehicle approaches the charged detachable main battery with the depleted detachable main battery coupled with the vehicle, after the depleted detachable main battery is disconnected from the vehicle, while the vehicle moves to the charged detachable main battery, and before the vehicle is connected with the charged detachable main battery.

Optionally, the vehicle is a mining vehicle.

Optionally, the converter is configured to conductively couple the auxiliary battery with the same circuit or circuits that the main batteries and the propulsion system are coupled with.

Optionally, the auxiliary battery is configured to power one or more traction motors of the propulsion system in the vehicle without the one or more traction motors being powered by another source.

Optionally, the auxiliary battery is configured to power the propulsion system of the vehicle for moving the vehicle without the propulsion system being coupled with any of the main batteries by a cable or other conductive pathway.

In one embodiment, a method includes moving a vehicle having an electrically powered propulsion system that is powered by a first main battery toward a charged second main battery, electrically decoupling the first main battery from the vehicle, moving the vehicle toward the charged second main battery by powering the propulsion system of the vehicle using an auxiliary battery that is onboard the vehicle after the first main battery is decoupled from the vehicle, electrically coupling the charged second main battery with the vehicle, and moving the vehicle by powering the propulsion system of the vehicle using the charged second main battery.

Optionally, the auxiliary battery is a low voltage battery.

Optionally, the main batteries are high voltage batteries.

Optionally, the method also includes charging the auxiliary battery by directing at least some electric energy stored in the charged second main battery to the auxiliary battery.

Optionally, the method also includes powering the vehicle with the auxiliary battery after the vehicle approaches the charged second main battery with the first main battery coupled with the vehicle, after the first main battery is disconnected from the vehicle, while the vehicle moves to the second main battery, and before the vehicle is connected with the second main battery.

Optionally, the vehicle is a mining vehicle.

Optionally, the method also includes conductively coupling the auxiliary battery with the same circuit or circuits that the main batteries and the propulsion system are coupled with.

Optionally, moving the vehicle toward the charged second main battery includes powering one or more traction motors of the propulsion system in the vehicle with the auxiliary battery and without the one or more traction motors being powered by another source.

Optionally, moving the vehicle toward the charged second main battery includes powering the propulsion system of the vehicle without the propulsion system being coupled with any of the main batteries by a cable or other conductive pathway.

Optionally, the method also includes powering the propulsion system of the vehicle with the auxiliary battery while the second main battery is detached from the vehicle and before a third main battery is coupled with the vehicle.

In one embodiment, a system includes an auxiliary battery configured to be disposed onboard a vehicle having an electrically powered propulsion system and a detachable main battery configured to be disposed onboard the vehicle and to power the propulsion system to move the vehicle. The main battery is configured to be detached from the propulsion system for charging the main battery. The system also includes a converter configured to be electrically coupled with the auxiliary battery, the propulsion system, and the main battery. The converter is configured to direct electric energy stored in the auxiliary battery to the propulsion system for powering the propulsion system while the vehicle is detached from the main battery and before the vehicle is re-connected with the main battery or a replacement main battery.

Optionally, the auxiliary battery stores less electric energy than the main battery or the replacement main battery.

Optionally, the converter is configured to charge the auxiliary battery with at least some electric energy stored in the main battery or the replacement main battery to the auxiliary battery.

Optionally, the vehicle is a mining vehicle.

Optionally, the converter is configured to conductively couple the auxiliary battery with a circuit that the main battery and the propulsion system also are coupled with.

Optionally, the auxiliary battery is configured to power one or more traction motors of the propulsion system in the vehicle to propel the vehicle without the one or more traction motors being powered by another source of electric energy.

Optionally, the auxiliary battery is configured to power the propulsion system of the vehicle for moving the vehicle without the propulsion system being coupled with the main battery or the replacement main battery by a conductive pathway.

In an embodiment, a vehicle (e.g., a mining vehicle) includes a propulsion system, an auxiliary battery, and a converter, all onboard the vehicle. The propulsion system is configured to be at least partially powered by electric current and is configured to also be powered by detachable main batteries. The converter is electrically coupled with the auxiliary battery and the propulsion system of the vehicle. The converter is configured to direct electric energy stored in the auxiliary battery to the propulsion system for powering the propulsion system while the vehicle is detached from a depleted detachable main battery and before the vehicle is connected with a charged detachable main battery. The auxiliary battery is a low voltage battery. The detachable main batteries are high voltage batteries. The converter is configured to charge the auxiliary battery by directing at least some electric energy stored in the charged detachable main battery to the auxiliary battery. The auxiliary battery is configured to power the vehicle after the vehicle approaches the charged detachable main battery with the depleted detachable main battery coupled with the vehicle, after the depleted detachable main battery is disconnected from the vehicle, while the vehicle moves to the charged detachable main battery, and before the vehicle is connected with the charged detachable main battery. The converter is configured to conductively couple the auxiliary battery with a circuit that the main batteries and the propulsion system also are coupled with. The auxiliary battery is configured to power one or more traction motors of the propulsion system in the vehicle without the one or more traction motors being powered by another source of electric energy. The auxiliary battery is configured to power the propulsion system of the vehicle for moving the vehicle without the propulsion system being coupled with any of the main batteries by a cable.

In an embodiment, a vehicle (e.g., a mining vehicle) includes an auxiliary battery, a detachable main battery, an electrically powered propulsion system, and a converter, all onboard the vehicle. The detachable main battery is configured to power the propulsion system to move the vehicle. The main battery is configured to be detached from the propulsion system for charging the main battery. The converter is electrically coupled with the auxiliary battery, the propulsion system, and the main battery. The converter is configured to direct electric energy stored in the auxiliary battery to the propulsion system for powering the propulsion system while the vehicle is detached from the main battery and before the vehicle is re-connected with the main battery or a replacement main battery. The auxiliary battery stores less electric energy than the main battery or the replacement main battery. The converter is configured to charge the auxiliary battery with at least some electric energy stored in the main battery or the replacement main battery to the auxiliary battery. The converter is configured to conductively couple the auxiliary battery with a circuit that the main battery and the propulsion system also are coupled with. The auxiliary battery is configured to power one or more traction motors of the propulsion system in the vehicle to propel the vehicle without the one or more traction motors being powered by another source of electric energy. The auxiliary battery is configured to power the propulsion system of the vehicle for moving the vehicle without the propulsion system being coupled with the main battery or the replacement main battery by a conductive pathway.

In an embodiment, a method includes moving a vehicle having an electrically powered propulsion system that is powered by a first main battery toward a charged second main battery. The method further includes electrically decoupling the first main battery from the vehicle. The method further includes moving the vehicle toward the charged second main battery by powering the propulsion system of the vehicle using an auxiliary battery that is onboard the vehicle after the first main battery is decoupled from the vehicle. The method further includes electrically coupling the charged second main battery with the vehicle. The method further includes moving the vehicle by powering the propulsion system of the vehicle using the charged second main battery. The method further includes charging the auxiliary battery by directing at least some electric energy stored in the charged second main battery to the auxiliary battery. The method further includes powering the vehicle with the auxiliary battery after the vehicle approaches the charged second main battery with the first main battery coupled with the vehicle, after the first main battery is disconnected from the vehicle, while the vehicle moves to the second main battery, and before the vehicle is connected with the second main battery. Moving the vehicle toward the charged second main battery includes powering the propulsion system of the vehicle without the propulsion system being coupled with any of the main batteries by a cable or other conductive pathway.

As used herein, an element or step recited in the singular and proceeded with the word “a” or “an” should be understood as not excluding plural of said elements or steps, unless such exclusion is explicitly stated. Furthermore, references to “one embodiment” of the presently described subject matter are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the subject matter described herein should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose several embodiments of the subject matter set forth herein, including the best mode, and also to enable a person of ordinary skill in the art to practice the embodiments of disclosed subject matter, including making and using the devices or systems and performing the methods. The patentable scope of the subject matter described herein is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

What is claimed is:

1. A system comprising:
an auxiliary battery configured to be disposed onboard a vehicle having a propulsion system that is configured to be at least partially powered by electric current and that is configured to also be powered by detachable main batteries; and
a converter configured to be electrically coupled with the auxiliary battery and the propulsion system of the vehicle, the converter configured to direct electric energy stored in the auxiliary battery to the propulsion system for powering the propulsion system while the vehicle is detached from a depleted detachable main battery and before the vehicle is connected with a charged detachable main battery.

2. The system of claim 1, wherein the auxiliary battery is a low voltage battery.

3. The system of claim 1, wherein the detachable main batteries are high voltage batteries.

4. The system of claim 1, wherein the converter is configured to charge the auxiliary battery by directing at least some electric energy stored in the charged detachable main battery to the auxiliary battery.

5. The system of claim 1, wherein the auxiliary battery is configured to power the vehicle after the vehicle approaches the charged detachable main battery with the depleted detachable main battery coupled with the vehicle, after the depleted detachable main battery is disconnected from the vehicle, while the vehicle moves to the charged detachable main battery, and before the vehicle is connected with the charged detachable main battery.

6. The system of claim 1, wherein the vehicle is a mining vehicle.

7. The system of claim 1, wherein the converter is configured to conductively couple the auxiliary battery with a circuit that the main batteries and the propulsion system also are coupled with.

8. The system of claim 1, wherein the auxiliary battery is configured to power one or more traction motors of the propulsion system in the vehicle without the one or more traction motors being powered by another source of electric energy.

9. The system of claim 1, wherein the auxiliary battery is configured to power the propulsion system of the vehicle for moving the vehicle without the propulsion system being coupled with any of the main batteries by a cable.

10. A method comprising:
moving a vehicle having an electrically powered propulsion system that is powered by a first main battery toward a charged second main battery;
electrically decoupling the first main battery from the vehicle;
moving the vehicle toward the charged second main battery by powering the propulsion system of the vehicle using an auxiliary battery that is onboard the vehicle after the first main battery is decoupled from the vehicle;
electrically coupling the charged second main battery with the vehicle; and
moving the vehicle by powering the propulsion system of the vehicle using the charged second main battery.

11. The method of claim 10, further comprising charging the auxiliary battery by directing at least some electric energy stored in the charged second main battery to the auxiliary battery.

12. The method of claim 10, further comprising powering the vehicle with the auxiliary battery after the vehicle approaches the charged second main battery with the first main battery coupled with the vehicle, after the first main battery is disconnected from the vehicle, while the vehicle moves to the second main battery, and before the vehicle is connected with the second main battery.

13. The method of claim 10, wherein moving the vehicle toward the charged second main battery includes powering the propulsion system of the vehicle without the propulsion system being coupled with any of the main batteries by a cable or other conductive pathway.

14. A system comprising:
an auxiliary battery configured to be disposed onboard a vehicle having an electrically powered propulsion system;
a detachable main battery configured to be disposed onboard the vehicle and to power the propulsion system to move the vehicle, the main battery configured to be detached from the propulsion system for charging the main battery; and
a converter configured to be electrically coupled with the auxiliary battery, the propulsion system, and the main battery, the converter configured to direct electric energy stored in the auxiliary battery to the propulsion system for powering the propulsion system while the vehicle is detached from the main battery and before the vehicle is re-connected with the main battery or a replacement main battery.

15. The system of claim 14, wherein the auxiliary battery stores less electric energy than the main battery or the replacement main battery.

16. The system of claim 14, wherein the converter is configured to charge the auxiliary battery with at least some electric energy stored in the main battery or the replacement main battery to the auxiliary battery.

17. The system of claim 14, wherein the vehicle is a mining vehicle.

18. The system of claim 14, wherein the converter is configured to conductively couple the auxiliary battery with a circuit that the main battery and the propulsion system also are coupled with.

19. The system of claim 14, wherein the auxiliary battery is configured to power one or more traction motors of the propulsion system in the vehicle to propel the vehicle without the one or more traction motors being powered by another source of electric energy.

20. The system of claim 14, wherein the auxiliary battery is configured to power the propulsion system of the vehicle for moving the vehicle without the propulsion system being coupled with the main battery or the replacement main battery by a conductive pathway.
